(19) United States
(12) Patent Application Publication
(10) Pub. No.: US 2003/0046305 A1
(43) Pub. Date: Mar. 6, 2003

(54) Method and system for assisting a professional person to advise a client

(76) Inventor: John Gerard Clarkson, Claremont (AU)

Correspondence Address: Carol W. Burton, Esq., Hogan & Hartson, LLP, Suite 1500, 1200 17th Street, Denver, CO, 80202, US

(21) Appl. No.: 10/023,429

(22) Filed: Dec. 13, 2001

(30) Foreign Application Priority Data
Aug. 24, 2001 (AU) PR7247

(51) Int. Cl. G06F 17/00; G06F 7/00; G06F 17/60

(52) U.S. Cl. 707/104.1; 705/2; 705/1

(57) ABSTRACT

A method and system for assisting a professional person to advise a client comprises a computer system 101, which presents a questionnaire to a client on a screen 104. The questionnaire includes a number of questions from which one or more answers can be selected. Each possible answer has an associated numerical value, and, by adding up the value for the selected answers, the computer system is able to provide indications regarding the client's position can be determined. This has particular application in the diagnosis of psychiatric disorders, and allows for a more complete diagnosis, which can be achieved more quickly.

### FIELD OF THE INVENTION

This invention relates to a method and system for assisting a professional person to advise a client. The invention has particular utility in the field of assisting medical practitioners to advise a patient, however the invention is also applicable in other professional fields.

### BACKGROUND ART

Time is an increasingly valuable commodity for professional advisors. Accordingly, any system which reduces the time required to perform a task or advise a client can represent a significant increase in efficiency for the professional.

One example of such an increase in efficiency is the medical industry, where medical practitioners diagnose and advise patients during a consultation. A typical consultation includes an information gathering period where the medical practitioner asks questions of the patient regarding their condition. Next, the medical practitioner will analyse the answers to the questions and arrive at a diagnosis of the patients condition, following which the medical practitioner will advise the client regarding the condition and suggest any necessary treatment.

Recently, attempts have been made to increase the efficiency with which medical practitioners can deal with patients by gathering information concerning the patients condition prior to the commencement of the consultation with the medical practitioner. Current systems involve a printed list of questions regarding a possible condition relevant to the patient, which the patient answers whilst waiting for the consultation with the medical practitioner. The patient's answers to the questions are presented to the medical practitioner immediately prior to the consultation with the patient to provide the medical practitioner with an opportunity to review the answers to the questions. This provides the medical practitioner with information regarding the patient's condition in a relatively short timespan compared with the medical practitioner verbally asking the patient questions.

The medical practitioner can either arrive at a diagnosis of the patient's condition from the answers to the printed questions, or alternatively may ask further questions of the patient during the consultation if required.

Whilst the above system provides efficiency improvements for the medical practitioner, in order for the medical practitioner to fully benefit from the questions, he or she needs to be knowledgeable in all of the conditions that may be initiated by each permutation or combination of answers to questions. Thus, there is a risk that the medical practitioner will miss the relevance of a particular combination of answers provided by the patient and will therefore not correctly diagnose, or not fully diagnose the patients condition. This results in the patient not receiving the best possible care and may delay the patient recovery. In addition, the present system tends to be “practitioner driven”, and often the patient is inhibited by the environment and other social conventions, and therefore does not—either deliberately or unconsciously—Interact honestly with the practitioner, thereby effecting any potential diagnosis.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of this invention, there is provided a method for assisting a professional person to advise a client, comprising the steps of:

presenting a plurality of questions to the client regarding a subject and receiving answers in response to the questions from the client;

analysing the answers from the client in a computer system according to predefined indicators for each question; producing from the analysis an indication of the relevance of the subject to the client; and

providing to the professional person the answers provided by the client and the indication of the relevance of the subject to the client.

Preferably, the method further comprises the step of presenting at least one further question to the client in response to at least one answer provided by the client.

Preferably, the method further comprises the step of presenting to the client, for some of the questions, a set of predefined answers from which the client selects one.

Preferably, the set of predefined answers is presented as a sliding scale.

Alternatively, the set of predefined answers is presented as a set of discrete answers.

Preferably, each answer in the predefined list has a corresponding predefined indicator in the computer system.

Preferably, the stop of analysing the answers comprises summing the predefined indicators for the answers to each question.

Alternatively, the step of analysing the answers comprises summing the predefined indicators for the answers to some of the questions, the questions for which the answers are summed being selected according to a predefined relationship.

More preferably, the step of producing an indication of the relevance of the subject comprises comparing the sum of the predefined indicators with a predefined list of ranges, with each range having a corresponding relevance indicator, and selecting the relevant indicator corresponding to a range that includes the sum of the predefined indicators for the answers.

Preferably, the method further comprises the step of storing records of consultations between the professional person and the client, each record including requests for questions on subjects from the professional person, wherein the method comprises subsequently presenting the client with a plurality of questions regarding the subjects requested by the professional person.

Preferably, the questions are adapted in response to the question being previously presented to the client.

Preferably, tests are compared to provide an indication of progress of the client.

Preferably, the stop of presenting the client with a plurality of questions and receiving answers therefrom is performed over a data network.

Preferably, the step of providing the answers and the indication of the relevance to the professional person is performed over a data network.

Preferably, the questions relate to medical conditions, and the answers provide an indication of one or more conditions in the patient.

In accordance with a second aspect of this invention, there is provided an apparatus for assisting a professional person to advise a client, comprising:

a database storing a plurality of questions grouped by subject, and predefined indicators associated with each question;

means for presenting to the client a plurality of questions regarding a subject and for receiving answers regarding those questions from the client;

analysis means responsive to the answers from the client and to the predefined indicators for the corresponding questions to produce an indication of the relevance of the subject to the client;

means for presenting the answers and the indication of the relevance to the professional person.

Preferably, said means for presenting to the client a plurality of questions is arranged to present at least one further question to the client in response to at least one answer provided by the client.

Preferably, said database includes a set of predefined answers associated with each question, said means for presenting to the client a plurality of questions being arranged to present to the client, with each question, a set of predefined answers from which the client selects one.

Preferably, the set of predefined answers is presented as a sliding scale.

Alternatively, the set of predefined answers is presented as a set of discrete answers

Preferably, each answer in the predefined set has a corresponding predefined indicator in database.

Preferably, said analysis means is arranged to sum the predefined indicators for the answers to each question.

Alternatively, said analysis means is arranged to sum the predefined indicators for the answers to some of the questions, the questions for which the answers are summed being selected according to a predefined relationship.

More preferably, said analysis means is arranged to produce the indication of the relevance of the subject by comparing the sum of the predefined indicators with a predefined list of ranges stored in the database, with each range having a corresponding relevance indicator, and to select the relevant indicator corresponding to a range that includes the sum of the predefined indicators for the answers.

Preferably, the database includes data records of consultations between the professional person and the client, each data record including requests from the professional person for questions on subjects, wherein the means for presenting to the client a plurality of questions is arranged to subsequently present the client with a plurality of questions regarding the subjects requested by the professional person.

Preferably, the apparatus further includes means for adapting the questions in response to the question being previously presented in the client.

Preferably, the apparatus further includes means for comparing tests to provide an indication of progress of the client.

Preferably, said means for presenting to the client a plurality of questions is arranged to present the questions to the client via a data network.

Preferably, said means for presenting the answers and the indication of the relevance to the professional person is arranged to present the answers and the indication to the professional person via a data network.

In yet another aspect of the present invention, there is provided a method for assisting a medical practitioner to advise a patient, comprising the steps of presenting a plurality of questions to the patient regarding the patient's condition and receiving answers in response to the questions from the patient, analysing the answers from the patient in a computer system according to predefined indicators for each question, producing from the analysis an indication of the relevance of the subject to the patient; and providing to the medical practitioner the answers provided by the patient and the indication of the existence of one or more conditions in the patient.

When used in the context of the medical practitioner environment, such a method and system allows patients to answer questions more honestly and succinctly—due to the potential anonymity of use—and therefore provide more accurate diagnoses. Constraints to diagnosis resulting from the practitioner's own limitations are also reduced. It also provides for a fuller diagnosis of existing and potential conditions, therefore allows a more holistic approach to treatment. The apparatus can allow a diagnosis to be completed more quickly. Thus the system becomes much more patient-driven, rather than doctor-driven.

### BRIEF DESCRIPTION OF THE DRAWINGS

The invention will now be described with reference to one embodiment thereof and the accompanying drawings, in which:

FIG. 1 is list of tables used in the database of the embodiment; and

FIG. 2 is a schematic representation of an apparatus of the present invention.

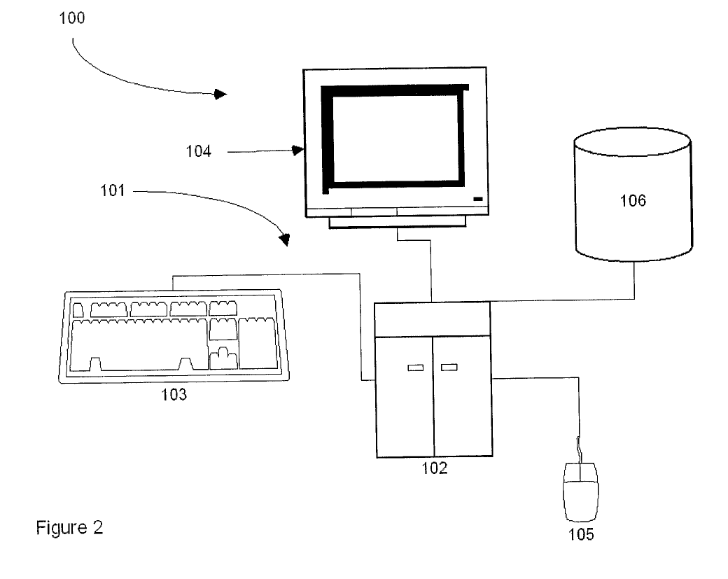

### BEST MODE(S) FOR CARRYING OUT THE INVENTION

The embodiment will be described with reference to a method and system for assisting a medical practitioner to provide medical advice to a patient. However, it should be appreciated that the invention is not limited to use in the medical profession.

The apparatus 100 of the embodiment includes a computer system 101 having a database 106 and application software stored in memory 107. The application software operates in response to information received from a medical practitioner, a patient and information in the database as will be described below. The computer system 101, in the present embodiment, is a standard personal computer comprising a processing unit 102, coupled to the database 106 and memory 107 and associated circuitry, as well as user interfaces such as a keyboard 103, screen 104 and a mouse 105. The use and operation of computers is well known to persons skilled in the art, and as such need not be described in any further detail herein, except as is relevant to the present invention. As an alternative a hand held computer or personal digital assistant could also be used to present the questionnaire to the patient. In this, the answers would then be sent to the processing unit 102 by any suitable means, such as wireless telemetry, for processing.

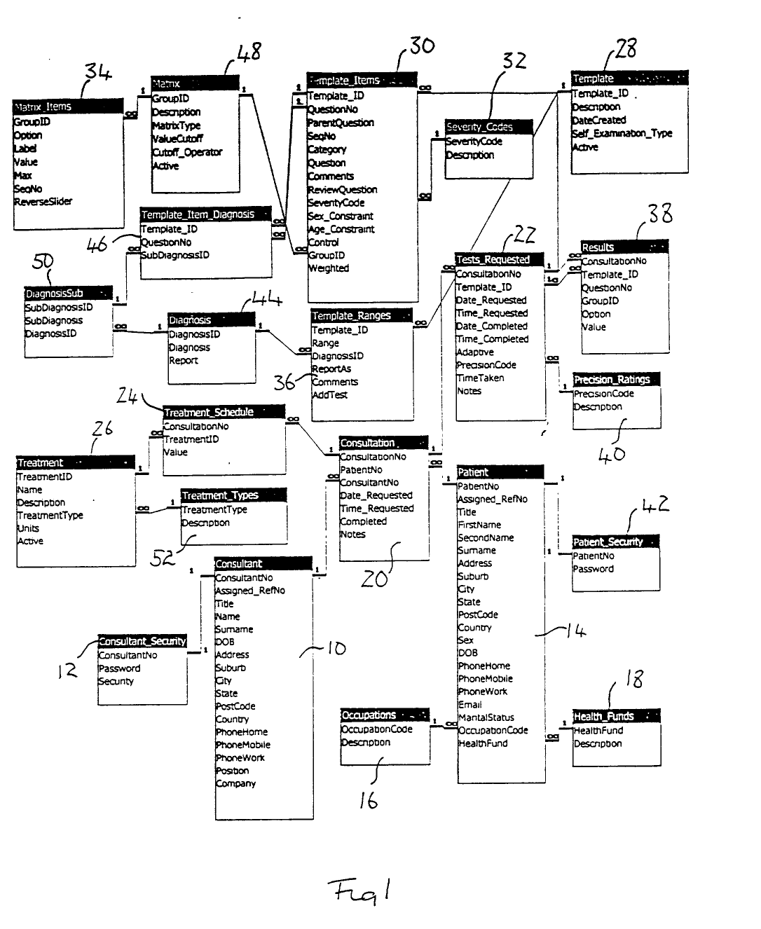

FIG. 1 shows the tables present in the database 106 and the relationships between them.

As shown, the database includes a consultant table 10 in which information for each medical practitioner is stored. Each entry in the consultant table 10 is associated with a corresponding entry in the consultant security table 12, which stores password access information for each consultant. The password access information for each consultant is for access into the application, and also provides security level access, which restricts access to certain areas of the application once the patient, practitioner or other user is logged in. The consultant security table 12 is provided in a separate table to the consultant table 10 for security purposes.

The database also includes a patient table 14 that stores information on each patient. Each entry in the patient table 14 includes an occupation code that references an entry in an occupation table 16, which describes the occupation of the patient. Each entry in the patient table 14 also includes a health fund field that references a health fund table 18, which describes the health fund of which the patient is a member. Each entry in the patient table 14 also includes a patient number field that is referenced by a consultation table 20—discussed below. The patient table 14 also references a patient security table 42. The patient security table 42 and is analogous to the consultant security table 12, and includes a password for each patient for access into the application, to provide increased security for the information.

The database also includes a consultation table 20 that records consultations between a medical practitioner from the consultant table 10 and a patient from the patient table 14. Each entry in the consultation table 20 relates to a specific consultation between the medical practitioner and a patient, along with tests requested by the medical practitioner, which are referenced in a test requested table 22, and the status of the treatment of the patient, which is referenced in a treatment schedule table 24. It should be appreciated that tests may be requested by the medical practitioner prior to the physical meeting of the patient and the medical practitioner, or may be requested during, or subsequent to, the consultation between the medical practitioner and the patient.

Each entry in the treatment schedule table 24 is referenced by a particular consultation from the consultation table 20. Each entry in the treatment schedule table 24 includes a treatment ID and an associated value. The value indicates the level of treatment selected. For example, if treatment is Drug A then the value will indicate the level/amount of Drug A as described by the units for the selected treatment in a treatment table 26, which in this case may be set to mg. Similarly if the treatment selected is counselling then the value will indicate the level of counselling as described by the units for the selected treatment in table 26 which in this case may be set to hours. This may include a reference to the treatment table 26 that contains a description of the treatment, as well as an entry regarding the treatment type, the units, and whether it is active. The treatment type references a treatment type table 52, which includes a description of the treatment type. The treatment types define a number of different types, or categories, of treatment. For example, a type “Chemical” may be used to describe all chemically manufactured drugs, a type “Natural” may used to define all natural medication, and a type “Other” may be used to indicate alternative treatment remedies or treatment such as counselling. The treatment suggested can be compared with the patient details to determine any potential conflicts. For example, some medications may not be appropriate for children, or the patient may be allergic to certain drugs. If there are any potential conflicts, then these can be highlighted.

The Treatment table 26 defines, in detail, a particular treatment. For example, TreatmentlD “DrugA” may define the drug Prozac. A detailed description of this treatment may be defined and stored in the description field. The treatment may be categorised by selecting the treatment type of “Chemical”, and the level of this treatment will be measured in the units field, which may be set to mg. The Active field is used to indicate whether or not this particular treatment can be currently selected through the user interface. If active is true, then the treatment is currently available for selection. All treatment definitions are kept for patient historical purposes.

Medical practitioners and patients may access the computer system 100 using any suitable communications or computing tool. For example, portable computing devices, or remote access via a communications network may be used as appropriate. Further, where required, data may be entered on behalf of the patient by an authorised party, such as where the patient is unable to enter information due to illness, disability or other circumstances.

As currently described, the system provides a convenient management tool for a medical practitioner, however the system offers further benefits to the medical practitioner in assisting in the diagnosis and treatment of patients as described below.

The database 106 further includes a template table 28 that describes a type of test that may be performed, and may also contain a description of the conditions for which the test is designed to provide an indication. Each test consists of a series of questions that are to be answered by a patient.

Each entry in the template table 28 references multiple entries in a template items table 30, one for each question in the test, and identified by the entry in the template table 28. The table also includes a self-examination type field. This field is usod to flag all templates that can be used for a patient's own self-assessment. Thus, in a self-requested test using this system, the patient could log on individually and select a test for their own self-assessment. The tests that they would be allowed to select from would be those tests that have been indicated as self-examination types, i.e. those tests that have the self-examination type field set to true.

The template items table 30 includes the question, any comments pertaining to the question, and a reference to an entry in a severity code table 32. The severity code table 32 includes a description of the possible security code associated with the question.

Any one question can relate to one or more conditions. So, for example, one question could be used in relation to Attention Deficit Disorder (ADD) and Depression, while another to Depression and Obsessive Compulsive Disorder (OCD), and so on.

The template items table 30 further includes a parent question field that may be NULL, or which may reference another question in the template items table 30. If the parent question field is not NULL, then the question is a sub-question of the parent question. Sub-questions are activated upon a particular response to the parent question as will be described in further detail below. Additional fields include sex and age constraints, and a control field—if appropriate. The table also has a weighted field. The weighted field in template items table 30 is used to indicate whether or not the stored result for this question will be added/totalled in the overall result—as will be discussed in more detail below. Some questions are only asked for the benefit of producing extra information to the practitioner and are therefore not included in the calculation of the final result.

The template items table 30 also references a template item diagnosis table 46, and is referenced by a matrix table 48.

The template table 28, in addition to referencing multiple entries in the template items question table 30 for the questions associated with the test, also references a template range table 36.

The matrix table 48 includes entries relating to the form that answers will take, such as multiple choice type response or sliding scale response, which can be indicated on the user interface as buttons or sliders, and which the patient can select or move as appropriate.

The Description field in the matrix table 48 is used to describe or give an overall definition for the matrix being defined. The MatrixType field is used to define the matrix type as defined above—that is either type BUTTONS or type SLIDER in the present embodiment.

The ValueCutoff and Cutoff Operator fields are used to define which matrix items—as defined in matrix items table 34, and discussed below—for the particular matrix defined in matrix table 48, when selected, are to treated as positive or negative values. This is important so that the system can calculate when to process sub group questions.

The process is determined by:

If result_value_selected Cutoff_Operator ValueCutoff = true then
If 1 >= 0.5 then:

Result is positive

Otherwise:

Result is negative

If Matrix is defined as-

GroupID:MATA
MatrixType:BUTTONS
ValueCutoff: 0.5
Cutoff_Operator:>=

And has Matrix_Items defined as:

| | | |
|---|---|---|
| GroupID:MATA | | |
| Option:Yes | Option:Maybe | Option:No |
| Value: 1 | Value: 0.5 | Value: 0 |

Then, when answering the questionnaire, it the patient selects either the “Yes” or “Maybe” buttons the result is treated as positive and if the question has subgroup questions then they will be processed/asked. Whereas, if the patient selects the “No” button the result is treated as a negative and, so, no subgroup questions to the parent question will be processed/asked.

The matrix table 48 references the matrix items table 34, referred to above. The matrix items table 34 includes entries defining possible answers to the questions referenced by the entry in the template table 28 along with a value associated with each possible answer. The matrix items table 34 can also set maximum limits for the answers—for example, it can set the maximum value for the sliding scale. The matrix items table 34 also includes a SeqNo field and a ReverseSlider field. The SeqNo field is only used/visible for BUTTON type matrices and the ReverseSlider field is only used/visible for SLIDER type matrices.

The SeqNo is used to indicate the order each item is displayed on the question form at application runtime when the page display is built.

The Reverse slider field is used to indicate the direction of a positive value that is displayed graphically to the patient.

When a slider question is asked, a normal slider will have the negative response selection at the left side of the control and a positive response to the right side of the control.

As an example, consider the following question that may be asked:

On a scale of 0 to 10, 0 being bad and 10 being good, how do you feel?

BAD - - - GOOD

If the reverse slider has been selected then the control assumes that graphically a positive and negative value will be treated in the reverse to the normal.

So, The same slider control as above will be treated as the following when the ReverseSlider field is indicated, but will still be displayed to the patient as above.

On a scale of 0 to 10, 0 being good and 10 being bad how do you feel?

GOOD - - - BAD

The result for a normal slider control is stored as selected on the control. (i.e. a selection of 7 on a scale of 0 to 10 is stored as 7. Where ReverseSlider is selected, the result is flipped that is a selection of 7 on a scale of 0 to 10 is stored as 3.

The label field in the matrix items table 34 relates to the associated label that is written to the button or slider control.

For button controls the label defines the button.

For slider controls the label defines the left and right bubbles either side of the control. To determine which part of the label is used for the left and right bubbles for a slider control the label definition must be delimited by a semicolon - ‘;’.

For a button control a label Yes, will force the label Yes to be printed on top of the button item.

For a slider control a label BAD; GOOD will force the left bubble to include the caption BAD and the right bubble to include the caption GOOD.

BAD - - - GOOD

The entries in the template item diagnosis table 46 define which questions in the template items table 30 relate to which condition(s).

The template item diagnosis table 46 includes a SubDiagnosis ID field that is referenced by a DiagnosisSub table 50. This DiagnosisSub table 50 also includes a SubDiagnosis field, and a DiagnosisID field, which references a diagnosis table 44, and which in turn references the template ranges table 36. Each question defined in template items table 30 belongs to one or more sub Diagnoses. The table template item diagnosis table 46 includes the subDiagnosisID. The DiagnosisSub table 50 defines a Sub Diagnosis and indicates which Diagnosis it belongs to. For any given subDiagnosis the system 100 knows the Diagnosis to which it belongs to as defined in the DiagnosisSub table 50.

The table definition is as follows:

SubDiagnosisID—The ID for the sub diagnosis.

SubDiagnosis—A description of the sub diagnosis.

DiagnosisID—Indicates the Diagnosis the sub diagnosis belongs to.

For example, a Psychological Diagnosis may be broken into a number of Phobic and/or other related sub diagnoses. By indicating where a question belongs to a number of sub diagnoses we can report all specific sub diagnoses that a patient has answered positive to under each diagnosis.

The Report field in the Diagnosis table 44 is an added description/definition/grammatical explanation phrase etc. that can be used to describe the diagnosis in a report.

The template range table 36 includes entries defining a range of values, along with an indication of the relevance of the subject to the patient, associated with that range. The template ranges table 36 defines a set of rules that, if they are true, are displayed to the patient or medical practitioner when looking at the tests overall results. The results for a template are accumulated for each diagnosis and compared against the template ranges table 36. Only those questions that have been indicated as having a weighting—i.e. the weighted field in the template items table 30 is true—and are NOT control questions—i.e. the Control field in the template items table 30 is false—will be totalled/accumulated, as will be discussed further below.

Thus, the template table 28, the template items table 30, the severity codes table 32, the matrix table 48, the matrix items table 34, the template item diagnosis table, the DiagnosisSub table 50, the diagnosis table 44, and the template range table 36 define sets of questions for each subject, severity codes associated with each question, and predefined answers and their type (for example, in the form of multiple choice, or sliding scale answers), from which the patient is required to select one. They also define which questions relate to which condition(s), and are able to define values associated with each answer, as well as a series of ranges, and corresponding indicators associated with the answers provided by the patient to the questions.

The template table 28 is referenced by entries in the tests requested table 22, one for each test for which the medical practitioner requires to be performed. As the patient enters answers to the questions, the results are stored in a results table 38, and the results are associated with the tests requested table 22. Each test can be given to a patient in one of two ways—either as a complete test, or as an adaptive test. In a complete test, each question in the template is asked to the patient. In an adaptive test, the questionnaire looks at the patient's previous results for the selected template and selectively asks questions that the patient answered in the positive for this template. The term “positive” in this context means when the patient has indicated that they are positive to the condition(s) defined by the question. . Thus, the same, standard test is given, but it is self-adjusting depending upon the current status of the patient. For example, it may not repeat information-gathering questions that have already been asked. Where questions are repeated, then the question will be rephrased to take account that it has been asked before—for example if a patient has answered a question “yes” then the new question will ask “do you still?”

The adaptive field in this tests requested table 22, if selected i.e. true, indicates that the test is to use adaptive testing methods. In addition, it a test is selected in the adaptive testing mode, but the patient has never done the particular template/test in question, then normal or complete testing methods will apply.

The GroupID and Option fields in the results table 38 are directly related to the GroupID and Option fields in the matrix items table 34. These, along with the TemplateID and Question No., are included in the results table 38 to exactly define a result as belonging to a particular template, question and option for a particular consultation/request instance. Advantageously, the result table 38 is not directly linked with the patient table 14, and thus the entries in the results table 38 may be analysed whilst maintaining patient confidentiality. This provides a valuable tool for medical researchers and practitioners to determine trends in patterns of answers and other valuable information from the accumulated results of patients in response to a test.

In use, a test for a patient is requested. This can occur from one of several sources. For instance, the patient can request a self-test as an isolated action, or prior to a consultation with a medical practitioner, or a medical practitioner may request a test prior to, as part of, during or after a consultation with a patient. Where the test is a self test requested by the patient, an entry in the consultation table 20 is created with a value in the consultant reference indicating that the test was requested by the patient. Where the test is requested by a medical practitioner, an entry is created in a consultation table 20 which references both the consultant 10 and the patient 14.

Along with an entry in the consultation table 20, an entry in the tests requested table 22 is created for each requested test. The computer system then communicates the questions, along with the possible answers, to the patient. This can be achieved in any suitable manner, such as by presenting the questions on the screen 104, for practitioner input, and from which the answers are later retrieved. Alternatively, tests could be presented and serviced to patients and consultants over the Internet. The user selects from the available answers—which can be presented in either multiple choice or sliding scale format —for each question, and the users answers are received and stored in the computer system 100 in the database 106 in the results table 38. This selection can be done by using the mouse 105 to click buttons or drag a sliding scale, as appropriate and as well known to persons skilled in the art.

If the patient has provided a prescribed response for any question that has sub-questions associated with it, the sub-questions are also asked of the patient in a similar manner to that described above.

Once all questions have been answered, the computer system determines which questions relate to which conditions, and calculates the sum of the values associated with each selected answer, in respect of each condition, in order to arrive at a result for each separate condition. In the embodiment described herein, for any one question, each answer will have the same value whatever condition it relates to.

Each result i.e. calculated value, is then compared with the entries in the template range table 36 and associated with the respective condition. Once the entry, whose range field corresponds with the value derived from the answers provided by the patient, is located in the template range table 36, the corresponding description from the template range table 36 is communicated, along with the questions and the patient's answers thereto, to the medical practitioner that requested the test, or in the case of a self-test, possibly to the patient. It should be appreciated that the indications provided in the template range table 36 do not constitute a diagnosis of the patients condition, but merely provide an indication of the relevance of particular answers, or combinations of answers, provided by the patient to one or more conditions that may affect the patient. The diagnosis resulting from that information is the responsibility of the medical practitioner.

This is communicated to the patient or practitioner (as appropriate) as a report. The report will draw on the results table 38 but will read and report different aspects depending upon who receives the report.

In addition, a precision ratings table 40 is provided which includes entries defining a range of precisions that may describe the results of a test requested by a medical practitioner. The test requested table 22 includes a reference to an entry in the precision ratings table 40 which may be established by the medical practitioner to provide a comment on the accuracy of the test having regard to their direct observation of the patient, or having regard to their diagnosis or a diagnosis of a specialist practitioner.

The system may also, on the basis of the answers provided by the patient, suggest other areas that the practitioner could further investigate and additional tests that the patient could perform. As mentioned above, the system can provide adaptive testing, and is therefore able to compare tests and to re-assess, measure improvement (as to the effectiveness of the treatment—whether chemical or non-chemical) and report this back to appropriate parties.

By allowing the medical practitioner to prescribe tests and questions for a patient prior to an appointment, and receiving the results of the questions along with an indication of the relevance of the subject matter of the questions to the patient, medical practitioners can derive a significant efficiency improvement. Further, the patient benefits from an analysis of the results of the questions in which conditions that may have been overlooked by the medical practitioner in reviewing the answers will be indicated by the computer system and drawn to the attention of the medical practitioner.

It should be appreciated that the term computer system used in the embodiment may described a single computer, or a collection of several computer systems which may be directly accessible by the medical practitioner and/or the patient, or may be accessible by a data network such as the internet. While the embodiment discloses a single test used to cover a number of conditions, a single test may be used for each condition.

It should be appreciated that the scope of this invention is not confined to the particular embodiment described above,

The claims defining the invention are as follows:

1. A method for assisting a professional person to advise a client, comprising the stops of:
presenting a plurality of questions to the client regarding a subject and receiving answers in response to the questions from the client;
analysing the answers from the client in a computer system according to predefined indicators for each question;
producing from the analysis an indication of the relevance of the subject to the client; and
providing to the professional person the answers provided by the client and the indication of the relevance of the subject to the client.

2. A method according to claim 1, wherein the method further comprises the step of presenting at least one further question to the client in response to at least one answer provided by the client.

3. A method according to claim 1, wherein the method further comprises the step of presenting to the client, for some of the questions, a set of predefined answers from which the client selects one.

4. A method according to claim 3, wherein the set of predefined answers is presented as a sliding scale.

5. A method according to claim 3, wherein the set of predefined answers is presented as a set of discrete answers.

6. A method according to any of claims 3, wherein the predefined list has a corresponding predefined indicator in the computer system.

7. A method according to claim 6, wherein the step of analyzing the answers comprises summing the predefined indicators for the answers to each question.

8. A method according to claims 6, wherein the step of analysing the answers comprises summing the predefined indicators for the answers to some of the questions, the questions for which the answers are summed being selected according to a predefined relationship.

9. A method according to claim 7, wherein the step of producing an indication of the relevance of the subject comprises comparing the sum of the predefined indicators with a predefined list of ranges, with each range having a corresponding relevance indicator, and selecting the relevant indicator corresponding to a range that includes the sum of the predefined indicators for the answers.

10. A method according to claim 8, wherein the step of producing an indication of the relevance of the subject comprises comparing the sum of the predefined indicators with a predefined list of ranges, with each range having a corresponding relevance indicator, and selecting the relevant indicator corresponding to a range that includes the sum of the predefined indicators for the answers.

11. A method according to claim 10, wherein the questions are adapted in response to the question being previously presented to the client.

12. A method as claimed in claim 10, wherein tests are compared to provide an indication of progress of the client.

13. A method according to claim 1, wherein the method further comprises the step of storing records of consultations between the professional person and the client, each record including requests for questions on subjects from the professional person, wherein the method comprises subsequently presenting the client with a plurality of questions regarding the subjects requested by the professional person.

14. A method according claim 1, wherein the step of presenting the client with a plurality of questions and receiving answers therefrom is performed over a data network.

15. A method according claim 1, wherein the step of providing the answers and the indication of the relevance to the professional person is performed over a data network.

16. An apparatus for assisting a professional person to advise a client, comprising:
a database storing a plurality of questions grouped by subject, and predefined indicators associated with each question;
means for presenting to the client a plurality of questions regarding a subject and for receiving answers regarding those questions from the client;
analysis means responsive to the answers from the client and to the predefined indicators for the corresponding questions to produce an indication of the relevance of the subject to the client;
means for presenting the answers and the indication of the relevance to the professional person.

17. An apparatus according to claim 14, further including means for presenting the answers and the indication of the relevance to the client.

18. An apparatus according to claim 14, wherein the means for presenting to the client a plurality of questions is arranged to present at least one further question to the client in response to at least one answer provided by the client.

19. An apparatus according to claim 14, wherein the database includes a sat of predefined answers associated with each question, said means for presenting to the client a plurality of questions being arranged to present to the client, with each question, a set or predefined answers from which the client selects one.

20. An apparatus according to claim 17, wherein the set of predefined answers is presented as a sliding scale.

21. An apparatus according to claim 17, wherein the set of predefined answers is presented as a set of discrete answers.

22. An apparatus according to claim 16, wherein each answer in the predefined set has a corresponding predefined indicator in database.

23. An apparatus according to claim 20, wherein the analysis means is arranged to sum the predefined indicators for the answers to each question.

24. An apparatus according to claim 20, wherein the analysis means is arranged to sum the predefined indicators for the answers to some of the questions, the questions for which the answers are summed being selected according to a predefined relationship.

25. An apparatus according to claim 21, wherein the analysis means is arranged to produce the indication of the relevance of the subject by comparing the sum of the predefined indicators with a predefined list of ranges stored in the database, with each range having a corresponding relevance indicator, and to select the relevant indicator corresponding to a range that includes the sum of the predefined indicators for the answers.

26. An apparatus according to claim 22, wherein the analysis means is arranged to produce the indication of the relevance of the subject by comparing the sum of the predefined indicators with a predefined list of ranges stored in the database, with each range having a corresponding relevance indicator, and to select the relevant indicator corresponding to a range that includes the sum of the predefined indicators for the answers.

27. An apparatus according to claim 14, wherein the database includes data records of consultations between the professional person and the client, each data record including requests from the professional person for questions on subjects, wherein the means for presenting to the client a plurality of questions is arranged to subsequently present the client with a plurality of questions regarding the subjects requested by the professional person.

28. An apparatus according to claim 26, further including means for adapting the questions in response to the question being previously presented to the client.

29. An apparatus according to claim 26, further including means for comparing tests to provide an indication of progress of the client.

30. An apparatus according to claim 14, wherein the means for presenting to the client a plurality of questions is arranged to present the questions to the client via a data network.

31. An apparatus according to claim 14, wherein the means for presenting the answers and the indication of the relevance to the professional person is arranged to present the answers and the indication to the professional person via a data network.

32. A method for assisting a medical practitioner to advise a patient, comprising the steps of:
presenting a plurality of questions to the patient regarding the patient's condition and receiving answers in response to the questions from the patient;
analysing the answers from the patient in a computer system according to predefined indicators for each question;
producing from the analysis an indication of the relevance of the subject to the patient; and
providing to the medical practitioner the answers provided by the patient and the indication of the existence of one or more conditions in the patient.
